(19) United States
(12) Patent Application Publication
(10) Pub. No.: US 2015/0029078 A1
(43) Pub. Date: Jan. 29, 2015

(54) MOBILE ELECTRONIC DISPLAY DEVICE

(71) Applicant: Nidhish Jose, Mount Prospect, IL (US)

(72) Inventor: Nidhish Jose, Mount Prospect, IL (US)

(21) Appl. No.: 14/340,184

(22) Filed: Jul. 24, 2014

Related U.S. Application Data
(60) Provisional application No. 61/857,898, filed on Jul. 24, 2013.
(60) Provisional application No. 61/874,592, filed on Sep. 6, 2013.
(60) Provisional application No. 61/877,510, filed on Sep. 13, 2013.

(51) Int. Cl. G06F 3/14; H04W 8/24

(52) U.S. Cl. CPC G06F 3/1454; H04W 8/24
USPC 345/2.3

(57) ABSTRACT

A mobile electronic display device comprising: a frame through which a license plate is mounted to a motor vehicle; one or more electronic displays mounted to the frame such that the one or more electronic displays are located adjacent to the mounted license plate; a controller in electrical communication with the one or more electronic displays, wherein the controller causes media content to be displayed on the one or more electronic displays; and a wireless input mechanism in communication with the controller through which media content is received and presented to the controller for the controller to cause to be displayed on the one or more electronic displays.

### BACKGROUND OF THE INVENTION

This application claims priority to and the benefit of U.S. Provisional Application 61/857,898, filed Jul. 24, 2013, U.S. Provisional Application 61/874,592, filed Sep. 6, 2013, and to U.S. Provisional Application 61/877,510, filed Sep. 13, 2013 both of which are hereby incorporated by reference.

### BACKGROUND OF THE INVENTION

The present device relates to a mobile electronic display device. More specifically, the present device relates to a Dynamic Display License Plate Frame (D.D.L.P.F.), which is a license frame for use on a vehicle to display messages and provides a means to update message contents dynamically. Message contents can be updated using a portable computing device, which requires user intervention, or remotely by a centralized web server.

Approximately 700 million vehicle (car) owners in United States use a license plate frame to mount the license plate on to the car. Most car dealerships are utilizing the display area in the license plate frame to display their advertisements, without providing any monetary benefit/services to the vehicle owner. Given that the average American spends approximately 3 or more hours per day in their vehicle, there would be considerable value in providing advertisements in a manner that benefits the owner of the vehicle.

There are some license plates available in the market that can display changing messages, but those frames can store only five messages or less. Currently there is no mechanism available to send and update messages to the license frames automatically and every time an update is required, a user would need to unscrew the frame and transfer the message through some type of portable device.

Accordingly, there is a need for a mobile electronic display device to display messages and provides a mechanism to automatically update message contents, as described herein.

### BRIEF SUMMARY OF THE INVENTION

To meet the needs described above and others, the present disclosure provides a mobile electronic display device to display messages and provides a mechanism to automatically update message contents.

By using the mobile electronic display device, vehicle owners are provided with an opportunity to gain monetary benefits and advertisers with a new medium to advertise their product, service etc.

The present mobile electronic display device will serve as an excellent medium for advertisers to display their advertisements or messages directly on the license plate frame. The mobile electronic display device may be updated in two ways: (1) remotely or; (2) with user intervention. Using the present display device, advertisers will be able to change or update content on the license plate frame frequently and have an opportunity to display different or changing advertisements/messages.

In an embodiment, a mobile electronic display device includes: a frame through which a license plate is mounted to a motor vehicle; one or more electronic displays mounted to the frame such that the one or more electronic displays are located adjacent to the mounted license plate; a controller in electrical communication with the one or more electronic displays, wherein the controller causes media content to be displayed on the one or more electronic displays; and a wireless input mechanism in communication with the controller through which media content is received and presented to the controller for the controller to cause to be displayed on the one or more electronic displays.

In some embodiments, the wireless input mechanism includes a general packet radio service module. Additionally, in some embodiments, the media content is received from a remote server. Moreover, in some embodiments, the media content is received and displayed with no human intervention. Further, in some embodiments, the wireless input mechanism includes a short-range wireless communication module. For example, in some embodiments, the short-range wireless communication module is a Bluetooth module. In further embodiments, the media content is received via satellite, for example using a satellite data service.

In some embodiments, the media content is received from a mobile electronic device in short-range communication with the wireless input mechanism. Additionally, in some embodiments, the controller is in communication with a mobile application resident in the mobile electronic device such that the controller causes notifications to display on the mobile electronic device.

In some embodiments, the controller is provided on a printed circuit board further including a power supply. Additionally, in some embodiments, the one or more electronic displays are LED displays. Further, in some embodiments, the controller is in communication with a vehicle ignition in the motor vehicle and the operation of the controller is, in part, based on a vehicle ignition condition.

In some embodiments, the controller is in communication with a light intensity sensor such that the controller varies of brightness of the one or more electronic displays in response to data from the light intensity sensor. Additionally, in some embodiments, the controller is in communication with a battery voltage monitor monitoring a battery in the motor vehicle and the operation of the controller is, in part, based on the battery voltage sensed by the battery voltage monitor. Moreover, in some embodiments, the controller validates any media content received through the wireless input mechanism prior to causing the media content to be displayed on the one or more electronic displays. For example, in some embodiments, the validation includes an analysis of the content of the media content. As an another example, in some embodiments, the validation includes an analysis of the source of the media content.

In some embodiments, the mobile electronic display device includes two electronic displays. For example, in some embodiments, a first of the electronic displays is located above a top edge of the license plate. As another example, in some embodiments, a second of the electronic displays is located below a bottom edge of the license plate. Additionally, in some embodiments, the controller is in communication with a SIM reader.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a front view of an example of a mobile electronic display device with an attached license plate.

FIG. 2 is a perspective view of an example of a mobile electronic display device.

FIG. 3 is a perspective view of another example of a mobile electronic display device.

FIG. 4 is a schematic view of the ecosystem of the mobile electronic display devices of the present invention.

### DETAILED DESCRIPTION OF THE INVENTION

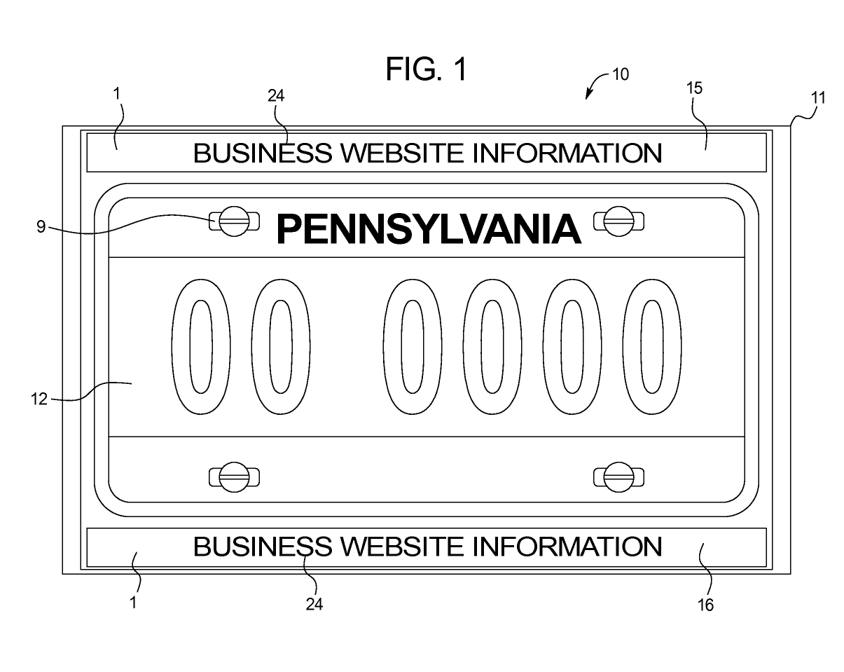

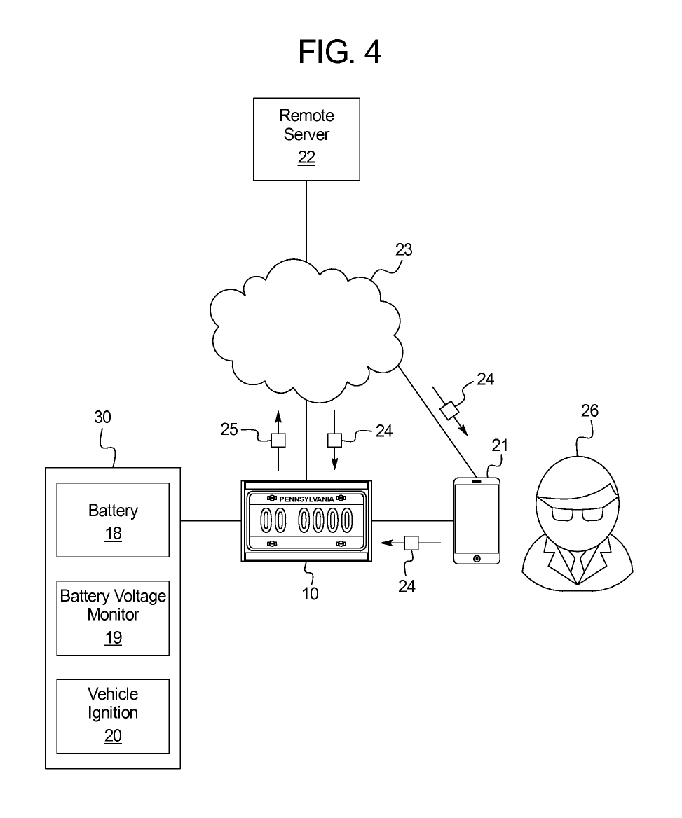

FIG. 1 illustrates an example of a mobile electronic display device 10. As shown in FIG. 1, the mobile electronic display device 10 may be used to secure a license plate 12 to a vehicle 30 (FIG. 4). Electronic displays 1 may be mounted around the license plate 12. In the embodiment shown in FIG. 1, an electronic display 1 is located above a top edge of the license plate, and a second of the electronic displays 1 is located below a bottom edge of the license plate. While the vehicle 30 is in use, the electronic displays 1 may display media content 24 viewable by passengers and drivers in nearby vehicles 30.

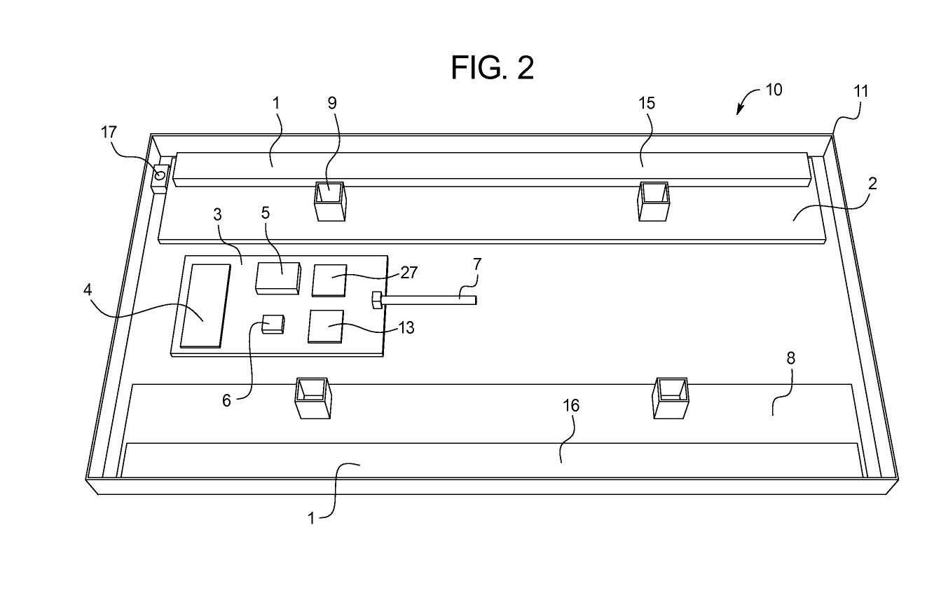

As shown in FIG. 4, the mobile electronic display device 10 may communicate with a remote server 22 or a mobile device 21 to receive update media content 24. In a first embodiment, shown in FIG. 2, the mobile electronic display device 10 uses remote message access, wherein a General Packet Radio Service (G.P.R.S) module 5 may be used the media content 24 is received from a remote server 22. The media content may be received and displayed with no human intervention. Thus, the owner of the vehicle 30 does not need to update content on the display 1. The mobile electronic display device 10 content may update by transmitting a message update request 25 to pull content from a remote server 22. Alternatively, the remote server 22 may “push” the media content 24 to the mobile electronic display device 10 remotely. In further embodiments, the media content 24 is received via satellite, for example using a satellite data service.

Media content 24 may include text, images, video, or other multimedia content. Media content 24 may include metadata that changes the display behavior of the mobile electronic display device 10. For example, media content 24 may include metadata indicating that the media content 24 may only be displayed in a particular geographic area. Thus, as the mobile electronic display device 10 cycles through media content 24, it may omit content not permitted in that area. Media content 24 may be paid advertising messages received from an advertising provider. Alternatively, media content 24 may be user-generated. If a user 26 desires to display his or her own media content 24, the user 26 may access a portal on the remote server 24 that will assist the user 26 in media content creation, validation and pushing of the media content 24 to the mobile electronic display device 10.

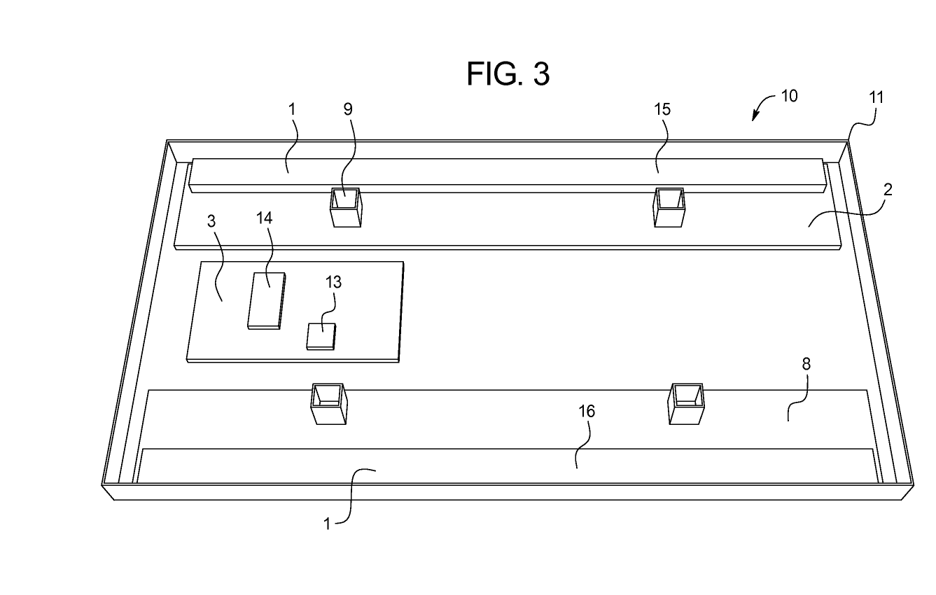

The second type of mobile electronic display device 10, shown in FIG. 3, is a mobile electronic display device 10 that receives media content 24 from a mobile device 21 of a user 26. When a message content update request 25 is created for a specific mobile electronic display device 10 in the remote server 22, the user 26 will receive an alert on his or her mobile device 21, such as a smartphone, tablet or laptop computer. The user 26 then may transfer the media content 24 from the mobile device 21 to the mobile electronic display device 10.

In a first embodiment shown in FIG. 2, a mobile electronic display device includes: a frame 11 through which a license plate 12 is mounted to a motor vehicle 30; one or more electronic displays 1 mounted to the frame 11 such that the one or more electronic displays 1 are located adjacent to the mounted license plate 12; a controller 13 in electrical communication with the displays 1 that controls the display of the media content 24 on the one or more electronic displays 1; and a general packet radio service module (GPRS) module 5 in communication with the controller 13 through which media content 24 is received and presented to the controller 13 for the controller 13 to cause to be displayed on the one or more electronic displays 1. As noted, in some embodiments, the GPRS module 5 may be substituted for a module to receive the media content 24 via satellite.

The frame 11 may be constructed from any suitable material, including metal, plastic, or any other material that can be secured to the vehicle 30, while also protecting the electronic components inside. The frame 11 may also be constructed to have any suitable shape and size appropriate for a particular vehicle 30. The frame 11 may include mounting holes 9 for receiving the license plate 12.

The controller 13 may be mounted on a main printed circuit board (PCB) 3 mounted on the frame 11. The controller 13 may be powered by power supply 4. Alternatively, a vehicle battery 18 may power the controller 13. The controller 13 may be microcontroller. In use, the controller 13 validates the source of the media content 24, manages the reception of the media content 24 and display of the media content 24 properly on the displays 1. For example, in some embodiments, the validation includes an analysis of the content of the media content 24. As another example, in some embodiments, the validation includes an analysis of the source of the media content 24.

In some embodiments, in order to display the media content 24 only while operating the vehicle 30, the controller 13 is in communication with a vehicle ignition 20 in the motor vehicle 30 and the operation of the controller is, in part, based on a vehicle ignition condition, such as the engine being turned on, the car being in motion, etc. Additionally, in some embodiments, the controller 13 is in communication with a light intensity sensor 17 such that the controller 13 varies of brightness of the one or more electronic displays 1 in response to data from the light intensity sensor 17. Further, in some embodiments, the controller 13 is in communication with a battery voltage monitor 19 monitoring a battery 18 in the motor vehicle 30 and the operation of the controller 13 is, in part, based on the battery voltage sensed by the battery voltage monitor 19. For example, if the battery voltage monitor 19 detects a voltage below a threshold voltage, the controller 13 may power off itself and the displays 1. The threshold voltage may be configurable and may vary based on the year make and model of the vehicle 30. The displays 1 will be turned ON when battery voltage again goes above the threshold voltage.

To provide sufficient space for media content 24, any number of displays 1 may be positioned anywhere on the frame 11, including on all four sides of the frame 11. In an embodiment, the displays 1 may be LED dot matrix displays 1. In other embodiments, the displays 1 may be any display technology available in the market, such as OLEDs or high quality displays 1. LED dot matrix displays 1 can display text in various languages and characters in different fonts and colors. As shown in FIG. 2, in one embodiment, an LED display top row 15 is provided above the license plate 12 and an LED display bottom row 16 is provided below the license plate 12. The LED display top row 15 may be mounted on a PCB upper row 2 in communication with the controller 13, and the LED display bottom row 16 may be mounted on a PCB lower row 8 in communication with the controller 13.

As noted, the mobile electronic display device 10 includes a GPRS module 5 in communication with a GSM antenna 7. The GPRS module 5 is a wireless input mechanism through which media content 24 is received. The GPRS module 5 is a packet oriented mobile data service module for receiving mobile data service. Using the mobile data service, the GPRS module 5 may receive media content 24 a remote server 22. In order to connect to the mobile data service, the GPRS module 5 and the controller may be in communication with a SIM reader 6 to read subscriber information off of a SIM card.

In some embodiments, the mobile electronic display device 10 may include a GPS module 27 within the frame to identify the location of the mobile electronic display device 10. This feature may be helpful for customers using dynamic advertising to track the locations where the particular media content 24 was displayed.

In a second embodiment shown in FIG. 3, a mobile electronic display device includes: a frame 11 through which a license plate 12 is mounted to a motor vehicle 30; one or more electronic displays 1 mounted to the frame 11 such that the one or more electronic displays 1 are located adjacent to the mounted license plate 12; a controller 13 in electrical communication with the displays 1 that controls the display of the media content 24 on the one or more electronic displays 1; and a Bluetooth module 14 in communication with the controller 13 through which media content 24 is received and presented to the controller 13 for the controller 13 to cause to be displayed on the one or more electronic displays 1. It is contemplated that in some embodiments the wireless mechanism may be short-range wireless communication subsystems other than a Bluetooth module 14.

As noted, in the second embodiment shown in FIG. 3, the mobile electronic display device 10 receives media content 24 from a mobile device 21 of a user 26. In an embodiment, in order to safely update the media content 24, certain conditions need to occur. Specifically, the following conditions should exist:
1. The vehicle ignition 20 should be fully OFF before the media content 24 can be updated (in some embodiments this may additionally be a requirement of remote updating by the remote server 22 to prevent driver distraction);
2. The user 26 must be near the mobile electronic display device 10, preferably within a distance of five meters, for user intervention using a mobile device 21 to be effective;
3. The mobile device 21 (including but not limited to, cell phones, smartphones, tablets, smart watches, laptops) Bluetooth-type function should be ON and accessible by the mobile electronic display device 10 to make the transfer of media content 24 possible.

As noted, in an embodiment, updating the media content 24 is permitted only when the vehicle ignition is OFF. In a less restrictive alternate embodiment, updating the media content 24 is permitted only when the vehicle is in PARK, although the ignition may be ON. In an even less restrictive embodiment, updating the media content 24 is permitted when the vehicle is moving at less that a programmable speed. Additionally, the programmable speed may capable of being updated as needed. The previous conditions may apply regardless of whether the content is updated remotely or with user intervention.

Operation of the mobile electronic display device 10 requires supporting applications and services. Some of these support services include the remote server 22, and a mobile electronic display device controlling application that may be executed by the mobile device 21.

The remote server 22 may perform many functions to coordinate the assembly and distribution of media content 24. For example, the remote server 22 may provide functionality for advertisers to create, edit and confirm media content 24, such as advertisements or messages for individual mobile electronic display devices 10. Advertisers may be provided an option to customize advertisements based on display devices owner location, travel route, travel timings etc. As another example, the remote server 22 may manage user profiles for display device owners and advertisers. A user profile may include an option to withdraw money from account in various payment types (to bank account, gift cards, store/retailer coupons etc.). Users 26 may be provided with a price bargain (bid) opportunity to give users 26 an option to negotiate price for a product(s) or on store/retailer coupons.

Additionally, the remote server 22 may include functionality to push messages to the display device owner mobile application (for example to mobile electronic display devices 10 of FIG. 3 with the Bluetooth module 14). Also, the remote server 22 may include functionality to push media content 24 to the mobile electronic display device 10 (with the GPRS module 5). Further, the remote server 22 may include functionality to permit users 26 of the mobile electronic display device 10 controlling application or using a mobile device 21, such as a smart watch, to save nearby media content 24 he or she has seen to their user profile. Even further, the remote server 22 may provide a location of mobile electronic display device 10 that may be used to find the vehicle location. Although described as a single server, multiple servers may provide the functionality of the remote server 22 and each server may provide only some or all of the functionality described as will be understood by one of ordinary skill in the art from the examples provided.

The display device owner mobile application will have multiple functions to perform and may include the following: display new media content notification when there is media content 24 to be transferred to mobile electronic display device 10; initiate media content 24 transfer to mobile electronic display device 10; capture and confirm media content transfer status and send status to remote server 22; access mobile phone location.

Additionally, the controller may execute stored instructions, including: validate the media content 24 source to prevent unauthorized mobile devices 21 from uploading media content 24; validate the correct formatting of media content 24 (Characters & symbols in the media content 24, character count etc.); perform LED display health check; save message to mobile electronic display device memory; and manage the display of media content 24.

As described, a controller 13 controls aspects of the mobile electronic display device 10 described herein. The controller 13 may be embodied in one or more controllers 13 that may be adapted run a variety of application programs, access and store data, including accessing and storing data in associated database (which may be embodied in one or more databases), and enable one or more interactions with the other components of the mobile electronic display device 10. Typically, the one or more controllers 13 are embodied in one or more programmable data processing devices. The hardware elements, operating systems, and programming languages of such devices are conventional in nature, and it is presumed that those skilled in the art are adequately familiar therewith.

For example, the one or more controllers 13 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory stores at least portions of instructions for execution by the CPU and data for processing in accord with the executed instructions.

The one or more controllers 13 may also include one or more input/output interfaces for communications with one or more processing systems. Although not shown, one or more such interfaces may enable communications via a network 23, e.g., to enable sending and receiving instructions electronically. The communication links may be wired or wireless.

The one or more controllers 13 may further include appropriate input/output ports for interconnection with one or more output displays and one or more input mechanisms serving as one or more user interfaces for the controller 13. For example, the one or more controllers 13 may include a graphics subsystem to drive the digital displays 1. The links of the peripherals to the system may be wired connections or use wireless communications.

Although summarized above as a PC-type implementation, those skilled in the art will recognize that the one or more controllers 13 also encompasses systems such as host computers, servers, workstations, network terminals, and the like. In fact, the use of the term controller 13 is intended to represent a broad category of components that are well known in the art.

Aspects of the systems and methods provided herein encompass hardware and software for controlling the relevant functions. Software may take the form of code or executable instructions for causing a controller 13 or other programmable equipment to perform the relevant steps, where the code or instructions are carried by or otherwise embodied in a medium readable by the controller 13 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. A mobile electronic display device comprising:
a frame through which a license plate is mounted to a motor vehicle;
one or more electronic displays mounted to the frame such that the one or more electronic displays are located adjacent to the mounted license plate;
a controller in electrical communication with the one or more electronic displays, wherein the controller causes media content to be displayed on the one or more electronic displays; and
a wireless input mechanism in communication with the controller through which media content is received and presented to the controller for the controller to cause to be displayed on the one or more electronic displays.

2. The mobile electronic display device of claim 1 wherein the wireless input mechanism includes a general packet radio service module.

3. The mobile electronic display device of claim 2 wherein the media content is received from a remote server.

4. The mobile electronic display device of claim 3 wherein the media content is received and displayed with no human intervention.

5. The mobile electronic display device of claim 1 wherein the wireless input mechanism includes a short-range wireless communication module.

6. The mobile electronic display device of claim 5 wherein the short-range wireless communication module is a Bluetooth module.

7. The mobile electronic display device of claim 6 wherein the media content is received from a mobile electronic device in short-range communication with the wireless input mechanism.

8. The mobile electronic display device of claim 7 wherein the controller is in communication with a mobile application resident in the mobile electronic device such that the controller causes notifications to display on the mobile electronic device.

9. The mobile electronic display device of claim 1 wherein the controller is provided on a printed circuit board further including a power supply.

10. The mobile electronic display device of claim 1 wherein the one or more electronic displays are LED displays.

11. The mobile electronic display device of claim 1 wherein the controller is in communication with a vehicle ignition in the motor vehicle and the operation of the controller is, in part, based on a vehicle ignition condition.

12. The mobile electronic display device of claim 1 wherein the controller is in communication with a light intensity sensor such that the controller varies of brightness of the one or more electronic displays in response to data from the light intensity sensor.

13. The mobile electronic display device of claim 1 wherein the controller is in communication with a battery voltage monitor monitoring a battery in the motor vehicle and the operation of the controller is, in part, based on the battery voltage sensed by the batter voltage monitor.

14. The mobile electronic display device of claim 1 wherein the controller validates any media content received through the wireless input mechanism prior to causing the media content to be displayed on the one or more electronic displays.

15. The mobile electronic display device of claim 14 wherein the validation includes an analysis of the content of the media content.

16. The mobile electronic display device of claim 14 wherein the validation includes an analysis of the source of the media content.

17. The mobile electronic display device of claim 1 including two electronic displays.

18. The mobile electronic display device of claim 17 wherein a first of the electronic displays is located above a top edge of the license plate.

19. The mobile electronic display device of claim 18 wherein a second of the electronic displays is located below a bottom edge of the license plate.

20. The mobile electronic display device of claim 1 where in the controller is in communication with a SIM reader.
